(19) United States
(12) Patent Application Publication
(10) Pub. No.: US 2025/0203318 A1
(43) Pub. Date: Jun. 19, 2025

(54) RADIO COMMUNICATION SYSTEM, BASE STATION APPARATUS, MOBILE TERMINAL APPARATUS, AND RADIO COMMUNICATION METHOD

(71) Applicant: NIPPON TELEGRAPH AND TELEPHONE CORPORATION, Tokyo (JP)

(72) Inventors: So TAKATANI, Tokyo (JP); Toshiro NAKAHIRA, Tokyo (JP); Daisuke MURAYAMA, Tokyo (JP); Takatsune MORIYAMA, Tokyo (JP)

(21) Appl. No.: 18/849,144

(22) PCT Filed: May 26, 2022
(86) PCT No.: PCT/JP2022/021628

§ 371 Date: Sep. 20, 2024

(51) Int. Cl. H04W 4/021

(52) U.S. Cl. CPC H04W 4/021

(57) ABSTRACT

A mobile terminal apparatus includes a receiver that receives, from a base station apparatus, information on a high-speed communication area in which a received power intensity of the mobile terminal apparatus is set to a predetermined value or more and data is able to be transmitted at a predetermined transmission rate or more; a processor that determines whether transmission data transmitted by the mobile terminal apparatus is able to be transmitted within a range of the high-speed communication area, based on moving route information of the mobile terminal apparatus; and a transmitter that transmits the transmission data within the range of the high-speed communication area when the transmission data is able to be transmitted within the range of the high-speed communication area.

### TECHNICAL FIELD

The present invention relates to a radio communication system, a base station apparatus, a mobile terminal apparatus, and a radio communication method.

### BACKGROUND ART

In a radio communication system in which a base station apparatus and a mobile terminal apparatus perform radio communication, a technique for controlling, on a per user basis, an amount of traffic transmitted is known (see, for example, NPL 1).

### CITATION LIST

### Patent Literature

[NPL 1] “Part 3: And I Control Wireless LAN ˜Communication Control for Using Wireless LAN More Comfortably˜” Net One Systems, [retrieved on Mar. 18, 1992], Internet <URL: https://www.netone.co.jp/knowledge-center/blog-column/knowledge_takumi_059/>

### SUMMARY OF INVENTION

### Technical Problem

In the related art, for example, communication is performed in the same manner even in places where a distance between a base station apparatus and a mobile terminal apparatus is long and power consumption is large, and, thus, there is a problem in that power utilization efficiency of the base station apparatus and the mobile terminal apparatus is low.

An embodiment of the invention has been made in view of the above-described problem, and provides a radio communication system that enhances power utilization efficiency of a base station apparatus and a mobile terminal apparatus while providing a communication quality required by the mobile terminal apparatus.

### Solution to Problem

In order to solve the above-described problem, a radio communication system according to an embodiment of the invention is a radio communication system in which a base station apparatus and a mobile terminal apparatus perform radio communication, the radio communication system including an area setting unit configured to set a high-speed communication area in which a received power intensity of the mobile terminal apparatus is set to a predetermined value or more and data is able to be transmitted at a predetermined transmission rate or more, a determination unit configured to determine whether transmission data transmitted by the mobile terminal apparatus is able to be transmitted within a range of the high-speed communication area, based on moving route information of the mobile terminal apparatus, and a data transmission unit configured to transmit the transmission data within the range of the high-speed communication area when the transmission data is able to be transmitted within the range of the high-speed communication area.

### Advantageous Effects of Invention

According to an embodiment of the invention, it is possible to provide a radio communication system that enhances power utilization efficiency of a base station apparatus and a mobile terminal apparatus while providing communication quality required by the mobile terminal apparatus.

### BRIEF DESCRIPTION OF DRAWINGS

FIG. 1 is a diagram illustrating an example of a system configuration of a radio communication system according to a present embodiment.

FIG. 2 is a diagram illustrating an example of a functional configuration of the radio communication system according to Example 1.

FIG. 3 is a flowchart illustrating an example of processing of the radio communication system according to Example 1.

FIG. 4 is a diagram illustrating an example of moving route selection processing according to the present embodiment,

FIG. 5 is a diagram illustrating an example of a functional configuration of a radio communication system according to Example 2.

FIG. 6 is a flowchart illustrating an example of processing of the radio communication system according to Example 2.

FIG. 7 is a diagram illustrating an example of hardware configurations of a base station apparatus and a mobile terminal apparatus according to the present embodiment.

### DESCRIPTION OF EMBODIMENTS

Hereinafter, an embodiment of the invention (the present embodiment) is described with reference to the drawings. The embodiment to be described hereinafter is merely an example, and an embodiment to which the invention is applied is not limited to the following embodiment.

### <System Configuration>

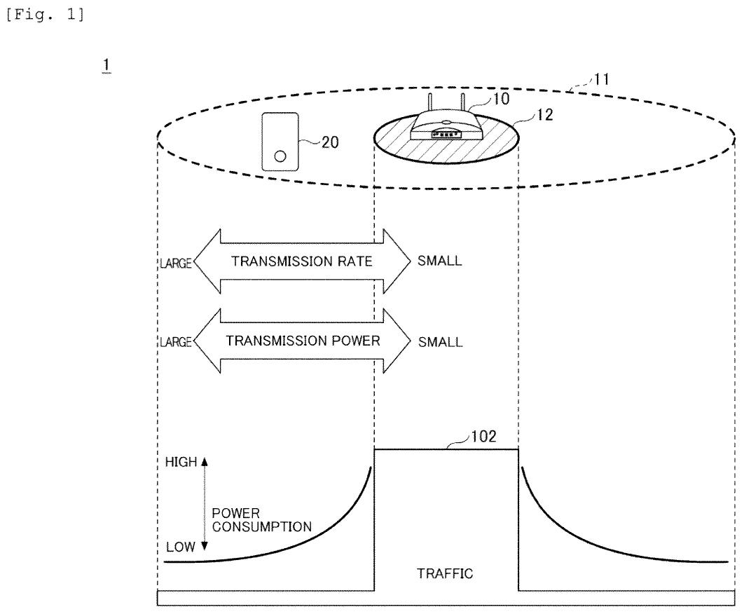

FIG. 1 is a diagram illustrating an example of a system configuration of a radio communication system according to an embodiment. A radio communication system 1 is a system in which a base station apparatus 10 and a mobile terminal apparatus 20 perform radio communication. A radio communication method of the radio communication system 1 may be various radio communication methods, such as those of 5th generation (5G), long term evolution (LTE), and a wireless local area network (LAN).

The mobile terminal apparatus 20 is a wireless station capable of radio communication with the base station apparatus 10 within a communication area 11 of the base station apparatus 10. It is assumed that the mobile terminal apparatus 20 according to the present embodiment is a terminal apparatus that can control the movement of, for example, a robot, a vehicle, or the like.

The base station apparatus 10 is a radio base station capable of radio communication with the mobile terminal apparatus 20 in a communication area 11 of the base station apparatus 10.

As illustrated in FIG. 1, when the mobile terminal apparatus 20 is separated from the base station apparatus 10, transmission power of the base station apparatus 10 and transmission power of the mobile terminal apparatus 20 are increased, and power consumption of the base station apparatus 10 and power consumption of the mobile terminal apparatus 20 are also increased.

In contrast, when the mobile terminal apparatus 20 approaches the base station apparatus 10, transmission power of the base station apparatus 10 and transmission power of the mobile terminal apparatus 20 are reduced, and power consumption of the base station apparatus 10 and power consumption of the mobile terminal apparatus 20 are also reduced. When the mobile terminal apparatus 20 approaches the base station apparatus 10, a received power intensity is increased, and a transmission rate is increased.

However, in the related art, communication is performed in the same manner even in places where a distance between the base station apparatus 10 and the mobile terminal apparatus 20 is long, and the power consumption is large, and, thus, there is a problem in that power utilization efficiency of the base station apparatus 10 and power utilization efficiency of the mobile terminal apparatus 20 are low.

Consequently, the radio communication system 1 according to the present embodiment has a function of setting a high-speed communication area 12 in which a received power intensity of the mobile terminal apparatus 20 during radio communication is set to a predetermined value P or more and data can be transmitted at a predetermined transmission rate T or more. The radio communication system 1 also has a function of controlling data transmission so as to transmit transmission data as much as possible within the range of the high-speed communication area 12.

For example, the radio communication system 1 determines whether transmission data transmitted by the mobile terminal apparatus 20 can be transmitted within the range of the high-speed communication area 12 based on moving route information and the like of the mobile terminal apparatus 20. When the transmission data can be transmitted within the range of the high-speed communication area 12, the radio communication system 1 transmits the transmission data within the range of the high-speed communication area 12.

In contrast, when the transmission data cannot be transmitted within the range of the high-speed communication area 12, the radio communication system 1 transmits the transmission data as much as possible within the range of the high-speed communication area 12 and transmits the remaining transmission data outside the range of the high-speed communication area 12.

When a moving process (for example, a staying time, a moving speed, a moving route, or the like) of the mobile terminal apparatus 20 can be changed, the radio communication system 1 may change the moving process of the mobile terminal apparatus 20 so as to be able to transmit the transmission data as much as possible within the range of the high-speed communication area 12.

In the high-speed communication area 12, a distance between the base station apparatus 10 and the mobile terminal apparatus 20 is sufficiently short, and, thus, the base station apparatus 10 and the mobile terminal apparatus 20 can transmit data at a high speed with less power consumption.

As described above, according to the radio communication system 1 of the present embodiment, it is possible to enhance power utilization efficiency of the base station apparatus and power utilization efficiency of the mobile terminal apparatus while providing communication quality required by the mobile terminal apparatus.

### <Functional Configuration>

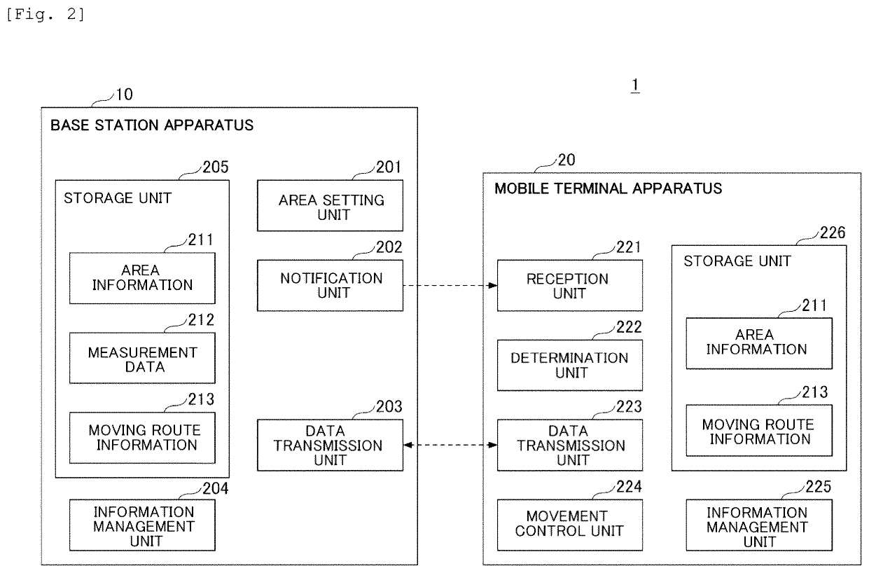

FIG. 2 is a diagram illustrating an example of a functional configuration of the radio communication system 1 according to the present embodiment.

### (Functional Configuration of Base Station Apparatus)

The base station apparatus 10 has, for example, a configuration of a computer, and an area setting unit 201, a notification unit 202, a data transmission unit 203, an information management unit 204, a storage unit 205, and the like are implemented by executing a predetermined program in the computer. At least a portion of each functional configuration described above may be implemented by hardware.

The area setting unit 201 executes area setting processing for setting the high-speed communication area 12 in which a received power intensity of the mobile terminal apparatus 20 is set to a predetermined value P or more and data can be transmitted at a predetermined transmission rate T or more.

For example, the base station apparatus 10 stores measurement data 212, which is a measurement result, by a measuring instrument, of a received power intensity measured at a plurality of measurement points in the communication area 11 of the base station apparatus 10, in the storage unit 205 or the like. The area setting unit 201 sets, based on the measurement data 212, a high-speed communication area 12 in which a received power intensity of the mobile terminal apparatus 20 is set to a predetermined value P or more and data can be transmitted at a predetermined transmission rate T or more.

The notification unit 202 executes notification processing for transmitting, to the mobile terminal apparatus, a notification of information on the high-speed communication area (hereinafter referred to as area information 211) which is set by the area setting unit 201. The area information 211 includes, for example, information indicating a location of the high-speed communication area 12, which has been set, and information on the predetermined transmission rate T.

For example, when the mobile terminal apparatus 20 is a robot or the like which moves on a predetermined moving route based on a digital map, the notification unit 202 may transmit, to the mobile terminal apparatus 20, the notification of the information indicating the location of the high-speed communication area 12 based on coordinate information on the digital map, and the like. Alternatively, the notification unit 202 may transmit, to the mobile terminal apparatus 20, a notification of the latitude and longitude of the base station apparatus 10, the radius of the high-speed communication area 12, and the like as the information indicating the location of the high-speed communication area 12.

The data transmission unit 203 executes data transmission processing for transmitting data in cooperation with a data transmission unit 223 of the mobile terminal apparatus 20. The data transmission unit 203 and the data transmission unit 223 transmit data at a transmission rate higher than or equal to the predetermined transmission rate T within the range of the high-speed communication area 12 which is set by the area setting unit 201. When the entire transmission data requested by the mobile terminal apparatus 20 cannot be transmitted within the range of the high-speed communication area 12, the data transmission unit 203 and the data transmission unit 223 transmit the remaining transmission data outside the range of the high-speed communication area 12.

The information management unit 204 stores, for example, moving route information 213 which is information on a moving route of the mobile terminal apparatus 20, the above-mentioned measurement data 212 and the like in the storage unit 205 and manages them. For example, an administrator or the like who administrates the radio communication system 1 can register the measurement data 212, the moving route information 213, and the like in the base station apparatus 10 by using a user interface (UI), a Web application programming interface (API), or the like provided by the information management unit 204.

The information management unit 204 may be a unit that obtains the moving route information 213 from the mobile terminal apparatus 20 and stores the obtained moving route information 213 in the storage unit 205.

The storage unit 205 is implemented by, for example, a program executed by a processor included in the base station apparatus 10, a storage device, a memory, and the like, and stores various types of information such as the area information 211, the measurement data 212, and the moving route information 213.

### (Functional Configuration of Mobile Terminal Apparatus)

The mobile terminal apparatus 20 has, for example, a configuration of a computer, and a reception unit 221, a determination unit 222, a data transmission unit 223, a movement control unit 224, an information management unit 225, a storage unit 226, and the like are implemented by executing a predetermined program in the computer. At least a portion of each functional configuration described above may be implemented by hardware.

The reception unit 221 executes reception processing for receiving the area information 211 transmitted by the notification unit 202 of the base station apparatus 10.

The determination unit 222 executes, based on the area information 211 received by the reception unit 221 and the moving route information 214 indicating the moving route of the mobile terminal apparatus 20, determination processing for determining whether transmission data transmitted by the mobile terminal apparatus 20 can be transmitted within the range of the high-speed communication area 12.

For example, when a request value of the transmission data transmitted by the mobile terminal apparatus 20 is assumed to be D, a period of time required for transmitting the transmission data at a transmission rate T can be calculated by (request value D/transmission rate T). When a moving distance in the high-speed communication area 12 of the mobile terminal apparatus 20 is assumed to be d and a moving speed in the high-speed communication area 12 of the mobile terminal apparatus 20 is assumed to be s, a period of time for the mobile terminal apparatus 20 to move in the high-speed communication area 12 can be calculated by (moving distance d/moving speed s). For example, when the following (Equation 1) is satisfied, the determination unit 222 determines that the transmission data transmitted by the mobile terminal apparatus 20 can be transmitted within the range of the high-speed communication area 12.

$$( request value D / transmission rate T ) < ( moving distance d / moving speed s ) \qquad ( Equation 1 )$$

The data transmission unit 223 executes data transmission processing for transmitting data in cooperation with the data transmission unit 203 of the base station apparatus 10 as described above.

The movement control unit 224 executes movement control processing for moving the mobile terminal apparatus 20 based on the moving route information 213 stored in the storage unit 205 or the like. For example, the movement control unit 224 controls a traveling device, a walking device, or the like provided in the mobile terminal apparatus 20 to move the mobile terminal apparatus 20.

A movement control device 24 changes a moving process of the mobile terminal apparatus 20 when the moving process of the mobile terminal apparatus 20 can be changed and the transmission data transmitted by the mobile terminal apparatus 20 cannot be transmitted within the range of the high-speed communication area 12. For example, the movement control device 24 changes the moving process of the mobile terminal apparatus 20 so that a period of time during which the mobile terminal apparatus 20 passes through the high-speed communication area 12 becomes longer.

The information management unit 225 stores, for example, moving route information 213, which is information on a moving route of the mobile terminal apparatus 20, and the like in the storage unit 226 and manages the information. For example, a user who uses the mobile terminal apparatus 20 or an administrator who administrates the mobile terminal apparatus 20 can register the moving route information 213 and the like in the mobile terminal apparatus 20 by using a UI, a web API, or the like provided by the information management unit 225.

The storage unit 226 is implemented by, for example, a program executed by the processor included in the mobile terminal apparatus 20, a storage device, a memory, and the like, and stores various types of information such as the area information 211 and the moving route information 213.

### <Flow of Processing>

Next, a flow of processing of a radio communication method according to Example 1 is described.

### Example 1

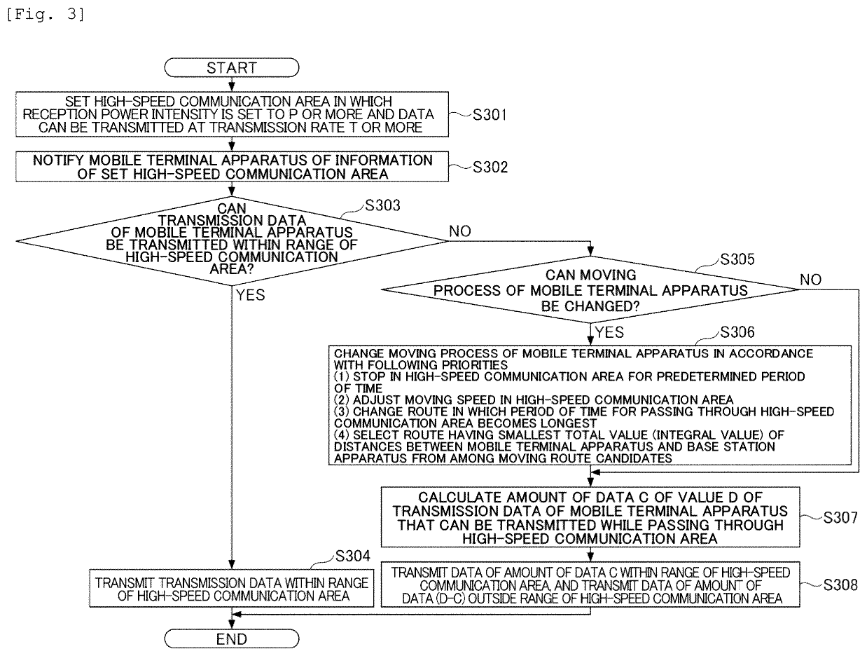

FIG. 3 is a flowchart illustrating an example of processing of the radio communication system according to Example 1. This processing illustrates an example of the processing executed by the radio communication system 1 according to Example 1 described with reference to FIG. 2.

In step S301, the area setting unit 201 of the base station apparatus 10 sets the high-speed communication area 12 in which a received power intensity is set to a predetermined value P or more and data can be transmitted at a predetermined transmission rate T or more. For example, the area setting unit 201 sets, based on the measurement data 212 stored in the storage unit 205, an area in which a received power intensity is set to a predetermined value P or more as the high-speed communication area 12.

In step S302, the notification unit 202 of the base station apparatus 10 transmits, to the mobile terminal apparatus 20, a notification of information on the high-speed communication area 12 which is set by the area setting unit 201. For example, the notification unit 202 transmits, to the mobile terminal apparatus 20, a notification of the area information 211 including information indicating a location of the high-speed communication area 12 which is set by the area setting unit 201, the information on the predetermined transmission rate T, and the like.

In step S303, the determination unit 222 of the mobile terminal apparatus 20 determines, based on the information of the high-speed communication area 12, which has been received, and the moving route information 213 stored in the storage unit 226, whether transmission data transmitted by the mobile terminal apparatus 20 can be transmitted within the range of the high-speed communication area 12. For example, the determination unit 222 determines whether the transmission data transmitted by the mobile terminal apparatus 20 can be transmitted within the range of the high-speed communication area 12 by using the above-mentioned Equation (1).

When the transmission data transmitted by the mobile terminal apparatus 20 can be transmitted within the range of the high-speed communication area 12, the determination unit 222 causes the processing to proceed to step S304. On the other hand, when the transmission data transmitted by the mobile terminal apparatus 20 cannot be transmitted within the range of the high-speed communication area 12, the determination unit 222 causes the processing to proceed to step S305.

When the processing proceeds to step S304, the data transmission unit 203 of the base station apparatus 10 and the data transmission unit 223 of the mobile terminal apparatus 20 transmit the transmission data within the range of the high-speed communication area 12. For example, when the mobile terminal apparatus 20 is out of the range of the high-speed communication area 12, the data transmission unit 203 and the data transmission unit 223 hold transmission of the transmission data. When the mobile terminal apparatus 20 is within the range of the high-speed communication area 120, the data transmission unit 203 and the data transmission unit 223 transmit the transmission data at a predetermined transmission rate T or more.

In contrast, when the processing moves from step S303 to step S305, the movement control unit 224 of the mobile terminal apparatus 20 determines whether a moving process (for example, a staying time, a moving speed, a moving route, or the like) of the mobile terminal apparatus 20 can be changed. For example, the movement control unit 224 may determine that the moving process can be changed when the moving process of the mobile terminal apparatus 20 is permitted to be changed and a delay in the time of arrival at a destination is allowed.

When the moving process of the mobile terminal apparatus 20 can be changed, the movement control unit 224 causes the processing to proceed to step S306. However, when the moving process of the mobile terminal apparatus 20 cannot be changed, the movement control unit 224 causes the processing to proceed to step S307.

When the processing proceeds to step S306, the movement control unit 224 of the mobile terminal apparatus 20 changes the moving process (for example, a staying time, a moving speed, a moving route, or the like) of the mobile terminal apparatus 20 so that a period of time during which the mobile terminal apparatus 20 passes through the high-speed Communication area 12 becomes longer. As a specific example, the movement control unit 224 changes the moving process of the mobile terminal apparatus 20 in accordance with the following priorities. Among the following priorities, a priority 1 is the highest and a priority 4 is the lowest.
(Priority 1) When the mobile terminal apparatus 20 can be stopped in the high-speed communication area 12, the movement control unit 224 stops the mobile terminal apparatus 20 in the high-speed communication area 12 for a predetermined period of time. For example, the movement control unit 224 stops the mobile terminal apparatus 20 in the high-speed communication area 12 for a predetermined period of time so that a period of time during which the mobile terminal apparatus 20 stays in the high-speed communication area 12 is set to (request value D/transmission rate T) or more.
(Priority 2) When the moving speed of the mobile terminal apparatus 20 can be changed, the movement control unit 224 adjusts the moving speed of the mobile terminal apparatus 20 in the high-speed communication area 12. For example, the movement control unit 224 adjusts the moving speed of the mobile terminal apparatus 20 in the high-speed communication area 12 so that a period of time during which the mobile terminal apparatus 20 stays in the high-speed communication area 12 is set to (request value D/transmission rate T) or more.
(Priority 3) When the moving route of the mobile terminal apparatus 20 can be changed, the movement control unit 224 changes the moving route of the mobile terminal apparatus 20 to a moving route in which a period of time during which the mobile terminal apparatus 20 passes through the high-speed communication area 12 becomes the longest.
(Priority 4) When the moving route of the mobile terminal apparatus 20 can be selected from among a plurality of moving route candidates, the movement control unit 224 selects a route having the smallest total value (integral value) of distances between the mobile terminal apparatus 20 and the base station apparatus 10 among the moving route candidates.

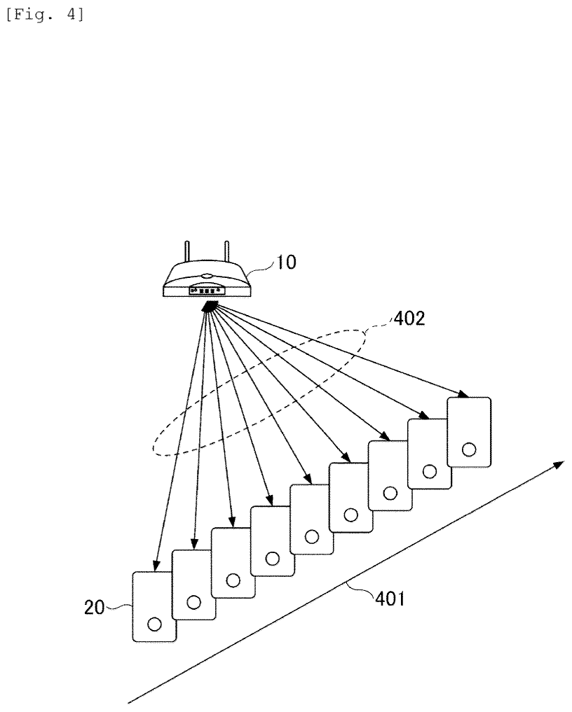

FIG. 4 is a diagram illustrating moving route selection processing according to the present embodiment. For example, it is assumed that the mobile terminal apparatus 20 moves in the direction of an arrow 401 in FIG. 4 in the high-speed communication area 12. In this case, the movement control unit 224 calculates the total (integral value) of distances 402 between the mobile terminal apparatus 20 and the base station apparatus 10. The movement control unit 224 selects a route having the smallest total (integral value) of the distances 402 between the mobile terminal apparatus 20 and the base station apparatus 10 among the moving route candidates.)

Here, referring back to FIG. 3, description of the flowchart is continued. When the processing proceeds to step S307, the data transmission unit 223 of the mobile terminal apparatus 20 calculates, of the request value D of the transmission data of the mobile terminal apparatus 20, the amount of data C which can be transmitted while the mobile terminal apparatus 20 passes through the high-speed communication area. The request value D indicates the amount of transmission data desired to be transmitted by the mobile terminal apparatus 20 within the communication area 11 of the base station apparatus 10.

In step S308, the data transmission unit 203 and the data transmission unit 223 transmit data of the amount of data C within the range of the high-speed communication area 12, and transmit data of the amount of data (D-C) outside the range of the high-speed communication area 12.

By the processing illustrated in FIG. 3, since the radio communication system 1 transmits more data in the high-speed communication area 12 with less power consumption, it is possible to enhance power utilization efficiency of the base station apparatus 10 and the mobile terminal apparatus 20 while providing communication quality required by the mobile terminal apparatus 20.

### Example 2

In the first embodiment, the mobile terminal apparatus 20 performs determination processing for determining whether the request value D of the transmission data of the mobile terminal apparatus 20 can be transmitted within the range of the high-speed communication area 12. In a second embodiment, an example is described in which a base station apparatus 10 performs determination processing for determining whether a request value D of transmission data of a mobile terminal apparatus 20 can be transmitted within the range of a high-speed communication area 12.

### <Functional Configuration>

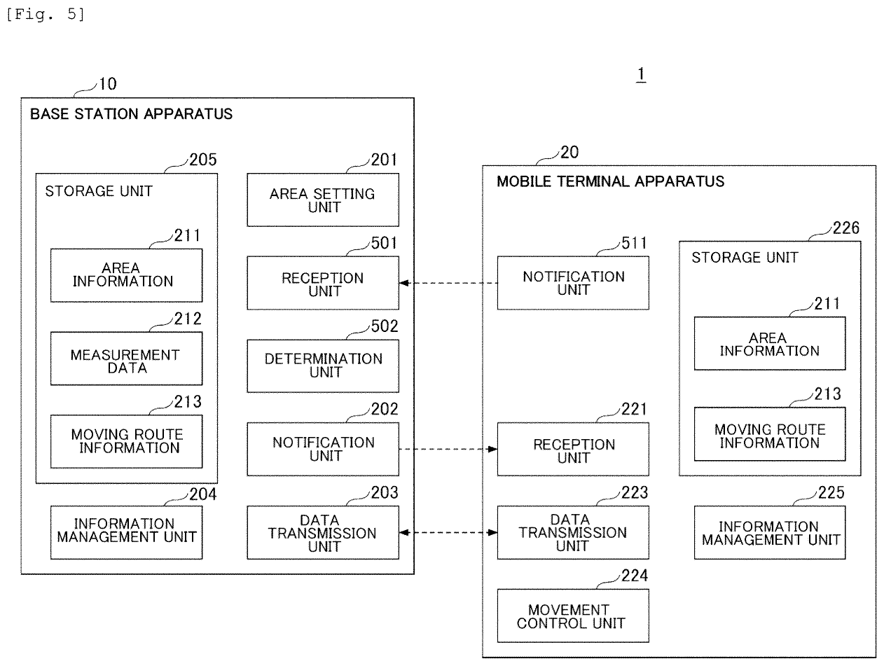

FIG. 5 is a diagram illustrating an example of a functional configuration of a radio communication system according to Example 2. A basic functional configuration of the radio communication system 1 according to Example 2 is the same as the functional configuration of the radio communication system 1 according to Example 1 described with reference to FIG. 2, and, thus, detailed description of the same functional configuration is omitted here.

### (Functional Configuration of Base Station Apparatus)

As illustrated in FIG. 5, the base station apparatus 10 according to Example 2 includes a reception unit 501 and a determination unit 502 in addition to the functional configuration of the base station apparatus 10 according to Example 1 described with reference to FIG. 2. The reception unit 501 and the determination unit 502 are implemented, for example, by a program executed by a computer included in the base station apparatus 10.

The reception unit 501 receives a request value D transmitted to the base station apparatus 10 by the mobile terminal apparatus 20.

The determination unit 502 determines whether transmission data transmitted by the mobile terminal apparatus 20 can be transmitted within the range of the high-speed communication area 12 based on area information 211, moving route information 214, and the request value D received by the reception unit 501.

The notification unit 202 transmits, to the mobile terminal apparatus 20, a notification of a determination result obtained by the determination unit 502, the area information 211 of the high-speed communication area 12, and the like.

In the functional configuration of the base station apparatus 10 according to Example 2, the other functional configurations may be the same as the functional configurations of the base station apparatus 10 according to Example 1.

### (Functional Configuration of Mobile Terminal Apparatus)

As illustrated in FIG. 5, the mobile terminal apparatus 20 according to Example 2 includes a notification unit 511 instead of the determination unit 222 which is the functional configuration of the mobile terminal apparatus 20 according to Example 1 described with reference to FIG. 2. The notification unit 511 is implemented, for example, by a program executed by a computer included in the mobile terminal apparatus 20.

The notification unit 511 transmits, to the base station apparatus 10, a notification of a request value D of transmission data transmitted by the mobile terminal apparatus 20.

The reception unit 221 according to Example 2 receives the determination result obtained by the determination unit 502, the area information 211 of the high-speed communication area 12, and the like which are transmitted to the mobile terminal apparatus 20 by the base station apparatus 10.

The other functional configurations of the mobile terminal apparatus 20 according to Example 2 may be the same as the functional configurations of the mobile terminal apparatus 20 according to Example 1.

### <Flow of Processing>

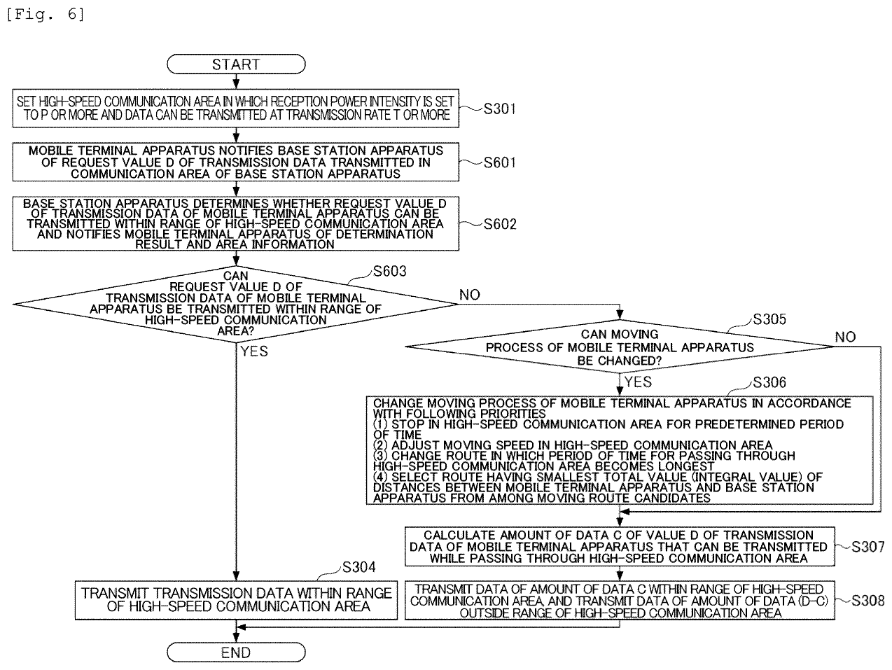

FIG. 6 is a flowchart illustrating an example of processing of the radio communication system according to Example 2. In the processing illustrated in FIG. 6, the processes of step S301 and steps S304 to S308 are the same as the processing of the radio communication system according to Example 1 described with reference to FIG. 3, and, thus, description thereof is omitted here.

In step S601, the notification unit 511 of the mobile terminal apparatus 20 transmits, to the base station apparatus 10, a notification of a request value D of transmission data transmitted in the communication area 11 of the base station apparatus 10.

In step S602, the determination unit 502 of the base station apparatus 10 determines whether transmission data transmitted by the mobile terminal apparatus 20 can be transmitted within the range of the high-speed communication area 12 based on the received request value D, the area information 211, the moving route information 213, and the like. For example, the determination unit 502 determines whether transmission data transmitted by the mobile terminal apparatus 20 can be transmitted within the range of the high-speed communication area 12 by using the above-mentioned Equation (1). The notification unit 202 of the base station apparatus 10 transmits, to the mobile terminal apparatus 20, a notification of a determination result obtained by the determination unit 502, the area information 211 which is information of the high-speed communication area 12, and the like.

In step S603, the mobile terminal apparatus 20 directs processing in accordance with the determination result received from the base station apparatus 10. When the request value D of the transmission data transmitted by the mobile terminal apparatus 20 can be transmitted within the range of the high-speed communication area 12 based on the determination result, the mobile terminal apparatus 20 causes the processing to proceed to step S304. In contrast, when the request value D of the transmission data transmitted by the mobile terminal apparatus 20 cannot be transmitted within the range of the high-speed communication area 12 based on the determination result, the mobile terminal apparatus 20 causes the processing to proceed to step S305.

By the processing illustrated in FIG. 6, in the radio communication system 1 according to Example 2, similar to the radio communication system 1 according to Example 1, it is possible to enhance power utilization efficiency of the base station apparatus 10 and the mobile terminal apparatus 20 while providing communication quality required by the mobile terminal apparatus 20. In this manner, the determination processing for determining whether the request value D of the transmission data of the mobile terminal apparatus 20 can be transmitted within the range of the high-speed communication area 12 may be performed by the base station apparatus 10 or by the mobile terminal apparatus 20.

Although an example of a case where the number of mobile terminal apparatuses 20 is one is described above, the number of mobile terminal apparatuses 20 that perform radio communication with the base station apparatus 10 may be two or more.

The base station apparatus 10 may have a function of controlling the number of mobile terminal apparatuses 20 in the high-speed communication area 12 when the number of mobile terminal apparatuses 20 performing radio communication with the base station apparatus 10 is large and a predetermined transmission rate T cannot be obtained in the high-speed communication area 12. For example, the base station apparatus 10 may instruct the mobile terminal apparatus 20 to change a moving process or a moving route so that the number of mobile terminal apparatuses 20 in the high-speed communication area 12 is less than or equal to a predetermined number.

### <Example of Hardware Configuration>

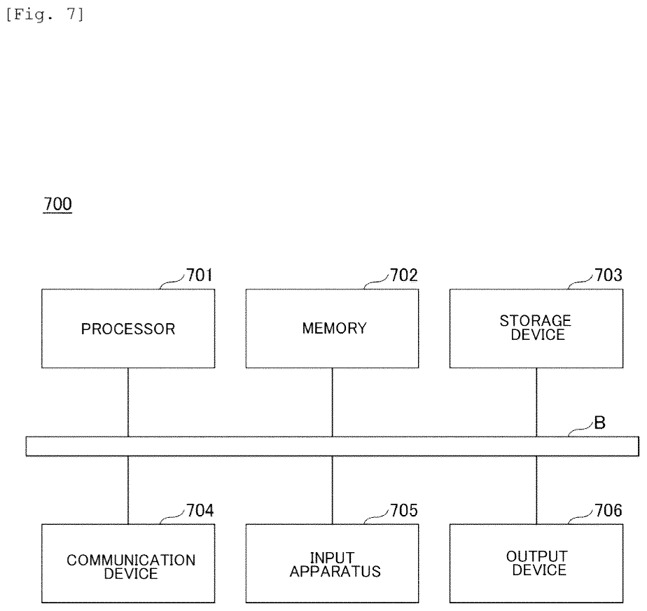

FIG. 7 is a diagram illustrating an example of hardware configurations of the base station apparatus and the mobile terminal apparatus according to the present embodiment. Each of the base station apparatus 10 and the mobile terminal apparatus 20 includes, for example, a hardware configuration of a computer 700 as illustrated in FIG. 7. In an example of FIG. 7, the computer 700 includes a processor 701, a memory 702, a storage device 703, a communication device 704, an input device 705, an output device 706, a bus B, and the like.

The processor 701 is, for example, an arithmetic logic unit such as a central processing unit (CPU) that implements various functions by executing a predetermined program. The memory 702 is a storage medium that is readable by the computer 700, and includes, for example, a random access memory (RAM), a read only memory (ROM), or the like. The storage device 703 is a computer-readable storage medium, and may include, for example, a hard disk drive (HDD), a solid state drive (SSD), various types of optical discs, a magneto-optical disc, and the like.

The communication device 704 includes one or more pieces of hardware (transmission and reception device) for performing communication with other devices via a wireless or wired network. The communication device 704 may include, for example, an antenna, a radio circuit, a communication processor for performing baseband processing and communication control processing, and the like.

The input device 705 is an input device (for example, a keyboard, a mouse, a microphone, a switch, a button, a sensor, or the like) that receives an input from the outside. The output device 706 is an output device (for example, a display, a speaker, an LED lamp, or the like) that performs an output to the outside. The input device 705 and the output device 706 may be integrated (for example, an input and output device such as a touch panel display).

The bus B is connected to the above-described components in common, and transmits, for example, address signals, data signals, various types of control signals, and the like. The processor 701 is not limited to the CPU, and may be, for example, a digital signal processor (DSP), a programmable logic device (PLD), a field programmable gate array (FPGA), or the like.

### Supplementary Notes

The base station apparatus 10 and the mobile terminal apparatus 20 in the present embodiment are not limited to being implemented by a dedicated device, and may be implemented by a general-purpose computer. In this case, a program for implementing this function may be recorded in a computer-readable recording medium, and the program recorded in this recording medium may be read by a computer system and executed. It is assumed that the “computer system” as mentioned here includes an OS and hardware such as peripheral devices.

The “computer-readable recording medium” includes portable mediums such as a flexible disc, a magneto-optical disc, a ROM, and a CD-ROM, and various storage devices such as a hard disk built into the computer system. The “computer-readable recording medium” may also include a recording medium that dynamically stores a program for a short period of time, such as a communication line when the program is transmitted via a network such as the Internet or a communication line such as a telephone line or a recording medium that stores a program for a certain period of time, such as a volatile memory inside a computer system serving as a server or a client in such a case.

The above-described program may be a program for implementing some of the above-described functions, may be a program capable of implementing the above-described functions in a combination with a program already recorded on the computer system, or may be a program implemented using hardware such as a programmable logic device (PLD) or a field programmable gate array (FPGA).

### Effects of Embodiment

According to the radio communication system 1 according to the present embodiment, it is possible to enhance power utilization efficiency of the base station apparatus 10 and the mobile terminal apparatus 20 while providing communication quality required by the mobile terminal apparatus 20.

### Conclusion of Embodiment

The present specification discloses at least a radio communication system, a base station apparatus, a mobile terminal apparatus, and a radio communication method according to the following items.

### (Item 1)

A radio communication system in which a base station apparatus and a mobile terminal apparatus perform radio communication, the radio communication system including:
an area setting unit configured to set a high-speed communication area in which a received power intensity of the mobile terminal apparatus is set to a predetermined value or more and data is able to be transmitted at a predetermined transmission rate or more;
a determination unit configured to determine whether transmission data transmitted by the mobile terminal apparatus is able to be transmitted within a range of the high-speed communication area, based on moving route information of the mobile terminal apparatus; and
a data transmission unit configured to transmit the transmission data within the range of the high-speed communication area when the transmission data is able to be transmitted within the range of the high-speed communication area.

### (Item 2)

The radio communication system according to item 1, further including:
a movement control unit configured to change a moving process of the mobile terminal apparatus so that a period of time during which the mobile terminal apparatus passes through the high-speed communication area becomes longer when the moving process of the mobile terminal apparatus is changeable and the transmission data is not able to be transmitted within the range of the high-speed communication area.

### (Item 3)

The radio communication system according to item 2, wherein, when the transmission data is not able to be transmitted within the range of the high-speed communication area, the movement control unit decreases a moving speed of the mobile terminal apparatus or stops the movement of the mobile terminal apparatus for a predetermined period of time in the high-speed communication area.

### (Item 4)

The radio communication system according to item 2, wherein, when the transmission data is not able to be transmitted within the range of the high-speed communication area, the movement control unit selects a route in which a period of time during which the mobile terminal apparatus passes through the high-speed communication area is the longest or a route in which an integral value of a distance between the mobile terminal apparatus and the base station apparatus is the smallest in the high-speed communication area.

### (Item 5)

The radio communication system according to item 1, wherein, when the transmission data is not able to be transmitted within the range of the high-speed communication area, the data transmission unit transmits the transmission data at the predetermined transmission rate or more within the range of the high-speed communication area and transmits the remaining transmission data outside the range of the high-speed communication area.

### (Item 6)

A base station apparatus that performs radio communication with a mobile terminal apparatus, the base station apparatus including:
an area setting unit configured to set a high-speed communication area in which a received power intensity of the mobile terminal apparatus is set to a predetermined value or more and data is able to be transmitted at a predetermined transmission rate or more;
a determination unit configured to determine whether transmission data transmitted by the mobile terminal apparatus is able to be transmitted within a range of the high-speed communication area based on moving route information of the mobile terminal apparatus; and
a data transmission unit configured to transmit the transmission data within the range of the high-speed communication area when the transmission data is able to be transmitted within the range of the high-speed communication area.

### (Item 7)

A mobile terminal apparatus that performs radio communication with a base station apparatus, the mobile terminal apparatus including:
a reception unit configured to receive, from the base station apparatus, information on a high-speed communication area in which a received power intensity of the mobile terminal apparatus is set to a predetermined value or more and data is able to be transmitted at a predetermined transmission rate or more;
a determination unit configured to determine whether transmission data transmitted by the mobile terminal apparatus is able to be transmitted within a range of the high-speed communication area based on moving route information of the mobile terminal apparatus; and
a data transmission unit configured to transmit the transmission data within the range of the high-speed communication area when the transmission data is able to be transmitted within the range of the high-speed communication area.

### (Item 8)

A radio communication method performed by a radio communication system in which a base station apparatus and a mobile terminal apparatus perform radio communication, the radio communication method including:
setting a high-speed communication area in which a received power intensity of the mobile terminal apparatus is set to a predetermined value or more and data is able to be transmitted at a predetermined transmission rate or more;
determining whether transmission data transmitted by the mobile terminal apparatus is able to be transmitted within a range of the high-speed communication area, based on moving route information of the mobile terminal apparatus; and transmitting the transmission data within the range of the high-speed communication area when the transmission data is able to be transmitted within the range of the high-speed communication area.

Although the present embodiment is described above, the invention is not limited to such a specific embodiment, and various modifications and changes can be made within the scope of the gist of the invention described in the claims.

### REFERENCE SIGNS LIST

1 Radio communication system
10 Base station apparatus
12 High-speed communication area
20 Mobile terminal apparatus
201 Area setting unit
203, 223 Data transmission unit
213 Moving route information
221 Reception unit
222, 502 Determination unit
224 Movement control unit

1. A mobile terminal apparatus comprising:
a receiver that receives, from a base station apparatus, information on a high-speed communication area in which a received power intensity of the mobile terminal apparatus is set to a predetermined value or more and data is able to be transmitted at a predetermined transmission rate or more;
a processor that determines whether transmission data transmitted by the mobile terminal apparatus is able to be transmitted within a range of the high-speed communication area, based on moving route information of the mobile terminal apparatus; and
a transmitter that transmits the transmission data within the range of the high-speed communication area when the transmission data is able to be transmitted within the range of the high-speed communication area.

2. The mobile terminal apparatus according to claim 1,
wherein the processor changes a moving process of the mobile terminal apparatus so that a period of time during which the mobile terminal apparatus passes through the high-speed communication area becomes longer when the moving process of the mobile terminal apparatus is changeable and the transmission data is not able to be transmitted within the range of the high-speed communication area.

3. The mobile terminal apparatus according to claim 2, wherein, when the transmission data is not able to be transmitted within the range of the high-speed communication area, the processor decreases a moving speed of the mobile terminal apparatus or stops the movement of the mobile terminal apparatus for a predetermined period of time in the high-speed communication area.

4. The mobile terminal apparatus according to claim 2, wherein, when the transmission data is not able to be transmitted within the range of the high-speed communication area, the processor selects a route in which a period of time during which the mobile terminal apparatus passes through the high-speed communication area is the longest or a route in which an integral value of a distance between the mobile terminal apparatus and the base station apparatus is the smallest in the high-speed communication area.

5. The mobile terminal apparatus according to claim 1, wherein, when the transmission data is not able to be transmitted within the range of the high-speed communication area, the transmitter transmits the transmission data at the predetermined transmission rate or more within the range of the high-speed communication area and transmits the remaining transmission data outside the range of the high-speed communication area.

6. A base station apparatus that performs radio communication with a mobile terminal apparatus, the base station apparatus comprising:
a processor that sets a high-speed communication area in which a received power intensity of the mobile terminal apparatus is set to a predetermined value or more and data is able to be transmitted at a predetermined transmission rate or more, and that determines whether transmission data transmitted by the mobile terminal apparatus is able to be transmitted within a range of the high-speed communication area based on moving route information of the mobile terminal apparatus; and
a transmitter that transmits the transmission data within the range of the high-speed communication area when the transmission data is able to be transmitted within the range of the high-speed communication area.

7. (canceled)

8. A radio communication method performed by a radio communication system in which a base station apparatus and a mobile terminal apparatus perform radio communication, the radio communication method comprising:
setting a high-speed communication area in which a received power intensity of the mobile terminal apparatus is set to a predetermined value or more and data is able to be transmitted at a predetermined transmission rate or more;
determining whether transmission data transmitted by the mobile terminal apparatus is able to be transmitted within a range of the high-speed communication area, based on moving route information of the mobile terminal apparatus; and
transmitting the transmission data within the range of the high-speed communication area when the transmission data is able to be transmitted within the range of the high-speed communication area.
